(19) United States
(12) Patent Application Publication
(10) Pub. No.: US 2004/0225654 A1
(43) Pub. Date: Nov. 11, 2004

(54) Techniques for invoking services based on patterns in context determined using context mining

(75) Inventors: Guruduth Somasekhara Banavar, Yorktown Heights, NY (US); John Sidney Davis II, New York, NY (US); Daby Mousse Sow, Riverdale, NY (US)

Correspondence Address: Ryan, Mason & Lewis, LLP, Suite 205, 1300 Post Road, Fairfield, CT, 06430, US

(73) Assignee: International Business Machines Corporation, Armonk, NY

(21) Appl. No.: 10/434,815

(22) Filed: May 9, 2003

(51) Int. Cl. G06F 7/00

(52) U.S. Cl. 707/6

(57) ABSTRACT

Services associated with one or more patterns of context about users are invoked. Patterns are determined within context corresponding to the one or more users. The patterns in the context are correlated with services. The services are invoked based on current context of the users. Context is data about the environment in which a given user is located, characteristics of a given user, qualities of a given user, or some combination of these. The patterns in the context may correlate or not correlate with services. Learned patterns do correlate with services and may be used to invoke the services when current context of a user indicates the user has performed the pattern, is performing the pattern, or will perform the pattern.

### FIELD OF THE INVENTION

The present invention relates to data mining and, more particularly, relates to mining data about users.

### BACKGROUND OF THE INVENTION

Context is data about the environment in which a given user is located, characteristics of a given user, qualities of a given user, or some combination of these. Examples of context include location of the user, temperature of the environment in which the user is located, the state of executing software or hardware being used by the user, as well as many other forms of environmental information. A user is generally a human, although a user may also be a machine, such as a computer or personal digital assistant (PDA).

There is a recent trend toward using context in order to provide some benefit to a user. For instance, a thermostat can be programmed to determine, with the aid of an infrared sensor, when a person is in a room and to adjust the temperature in the room accordingly. Similarly, infrared sensors can be used to turn on lights in a bathroom or another relatively unused room. The thermostat and infrared sensor can be considered to be controlled by a service, which is an executable entity.

A key challenge to using context to provide benefits to a user is that each service is generally user dependent. Different users require different kinds of context and context values for constructing services. In the thermostat example given above, two different users may desire quite different temperatures. Hence, each instance of a service will require a degree of customization by a developer in order to tailor the service to the user it will serve. This is a very complex problem. Program development, as used to create a service, is already a time-consuming process, and the added strain of customizing services on a per user basis will significantly slow down deployment of services that use context to provide a benefit to a user.

Thus, what is needed are improved techniques for using services that use context and that can pertain to a user or multiple users.

### SUMMARY OF THE INVENTION

Techniques are presented for determining patterns in context for users and for using the patterns of context to invoke services correlated to the patterns.

In an aspect of the invention, a number of patterns are determined in context corresponding to a number of users. A pattern in context is some data in the context that repeats. Generally, the data repeats multiple times and a pattern for the data may be determined through known techniques. Patterns in the context are correlated with one or more of a number of services, although some patterns in the context may or may not correlate with services. A service that correlates with a pattern in context is invoked based on the current context of a user. The current context can indicate that the pattern has occurred, is occurring, or will occur.

For instance, a pattern in context could be that a person sets a thermostat at a first value when leaving a house and then resets the thermostat at a second value when arriving at the house. Even if the person forgets to set the thermostat periodically, patterns can be determined from the context of setting and resetting the thermostat. A first pattern might be that when the person leaves the house, the thermostat should be set to the first value. The second pattern might be that when the person arrives back at the house, the thermostat should be set to the second value. Leaving and arriving might be determined via locations determined through a cellular phone system, logging onto or off of a computer system, or using a badge access during ingress or egress from a workspace. If a service is available for setting and resetting the thermostat, then the service can be automatically invoked at the appropriate times in order to set or reset the thermostat.

In another aspect of the invention, a service is an executable entity. A service can include a triggering component and an effecting component. The triggering component in a service generally contains logic that determines when and how the service should be executed. The effecting component in a service contains logic that determines what the service should do, once the service is triggered.

An application may be generated, where the application comprises one or more of the services. The application can be executed, thereby executing the one or more services.

In an additional aspect of the invention, patterns of context may or may not correlate with services. Correlating patterns in context about a user can create learned patterns, where the learned patterns do correlate a number of services to a number of patterns of context. Generally, a learned pattern comprises a condition-action pair. The condition and action are both sets of events. The events in the condition trigger the events in the action. Correlation of patterns in context to services may be performed through machine-learning techniques such as decision tree algorithms or association rule algorithms.

In yet another aspect of the invention, the services may be invoked by sending a message to the service to begin execution, by executing the service, through remote service invocation (such as a remote procedure call in JAVA) or through any other technique that causes a service to execute.

A more complete understanding of the present invention, as well as further features and advantages of the present invention, will be obtained by reference to the following detailed description and drawings.

### BRIEF DESCRIPTION OF THE DRAWINGS

FIG. 1 is block diagram of an application generation module for generating applications comprising sets of services in accordance with a preferred embodiment of the invention;

FIG. 2 is a block diagram of multiple application generation modules in a distributed embodiment;

FIG. 3 is a flowchart of an exemplary method for correlating patterns in context with services;

FIG. 4 is a flowchart of an exemplary method for determining when patterns exist in current context;

FIG. 5 is a flowchart of an exemplary method for invoking services that are correlated to patterns in context; and

FIG. 6 is a block diagram of an application generation module for an example where the context is website information.

### DETAILED DESCRIPTION OF PREFERRED EMBODIMENTS

Pervasive, context-aware computing is the process of automatically observing and making inferences on behalf of a user about environmental data from disparate sources. An important aspect of context-aware computing is making and using inferences to simplify the activities of users. An inferring process generally has a task of determining an intent of a user. Motion detector based light switches are a simple example of such an inferring process that uses context to simplify an activity: given that a user is present (e.g., motion has been detected) then turn on the lights (presumably what the user intended to happen). The process found in such systems is generally present in pervasive, context-aware applications: an inference is made about context that drives a corresponding action.

Recent advances in sensor technology as well as the development of widely accepted networking protocols are enabling the widespread emergence of pervasive, context-aware computing applications. Pervasive, context-aware applications will be afforded the use of multiple types of context from sources that were previously unavailable. Instead of simply relying upon one source of context such as detected motion, a system will be able to integrate motion detection with such context as the state of a calendar of a user and the location of a cell phone of a user. The multiplicity of context available is a distinction that separates pervasive, context-aware computing from previous work on intelligent agents and expert systems. A broad set of context afforded by recent work in sensor networks enables pervasive, context-aware applications to leverage a large set of data to bolster confidence in making inferences. This is a level of confidence that was rarely available previously.

As previously described, a key challenge to the development of such applications is that the inferring process associated with each application is generally very user dependent. As explained above, different users require different kinds of context and context values for constructing a given inference. Hence, each instance of a pervasive, context-aware application will require a degree of customization by the developer in order to tailor the application to the user it will serve. This degree of customization is onerous and could potentially lead to reduced deployment or no deployment of pervasive, context-aware computing.

The present invention solves these problems by providing techniques that may be used to automatically invoke services based on context for users. The services may be part of an application so that the application can be executed, thereby invoking the services.

The present invention can provide apparatus, methods and articles of manufacture that permit applications to be created that make inferences based on context. The applications may be designed, developed or implemented in a manner that allows the application to operate similarly and successfully for multiple users while utilizing distinct context from each user. Additionally, the present invention can provide a framework within which pervasive, context-aware computing applications can be designed, developed or implemented in a manner that alleviates the challenges of customization that developers of such applications currently face. Pervasive, context-aware computing applications that can be designed, developed or implemented in this framework include all applications that can take data from context as input and that can perform an action on behalf of a number of users. Generally, data from context have characteristics that are highly correlated to individual users about which the data is collected.

As an example of a pervasive, context-aware computing application that could be designed, developed or implemented by the present invention, the application may utilize location, computer activity and calendar information, which are all examples of context, to predict when a user is about to drive from home to work and when a user is about to drive home after work. Based on this context, the application may discover patterns about the user to facilitate prediction and then engage in the action of adjusting the home thermostat for the user for proper temperature regulation.

The present invention can log context that is associated with a vocabulary. A vocabulary is a collection of names of data in context. A vocabulary may be implemented as a schema of attributes and values. Context, as described in more detail below, is data about the environment in which a given user resides, characteristics of a given user, qualities of a given user, or some combination of these. The logged context may be collected from networked sources and then mined for patterns in context. The patterns in context may then be correlated with services that can be invoked. The correlation process can involve mapping a given pattern in context to available services.

An advantage of the present invention is that the present invention allows patterns in context that are not easy to recognize or characterize to be determined and then utilized to facilitate services. This advantage results in certain benefits, of which two will be discussed here. The first benefit corresponds to a case in which an application developer is aware of a particular pattern in context in which a user engages. The present invention allows the pattern in context to be recognized and correlated to appropriate services without direct intervention by the developer. The second benefit corresponds to the case in which an application developer is not aware (or is only partially aware) of appropriate patterns in context engaged in by a user and the corresponding services that might be associated with a pattern in context. In this case, the present invention discovers patterns in context and appropriate services that correlate with the patterns in context. A result is that applications may be automatically generated.

In the present disclosure, the following definitions are used. A service is an executable entity. It generally has two components, a triggering component and an effecting component. Triggering is any process that determines patterns in context and maps these patterns to appropriate services. The triggering component in a service generally contains logic that determines when and how the service should be executed. Effecting is any process that performs actions based on patterns in context. The effecting component in a service contains logic that determines what the service should do, once the service is triggered. A user comprises a human or machine about which context is collected. An application comprises a set of one or more services. Context, as previously described, is data about the environment in which a given user resides, characteristics of a given user, qualities of a given user, or some combination of these. As described above, a pattern in context is some data in context that repeats. Generally, the data repeats multiple times and a pattern for the data may be determined through known techniques. A pattern in context may or may not correlate with one or more services. A learned pattern is a condition-action pair. The condition and action are both sets of events. The events in the condition trigger the events in the action. A learned pattern correlates a pattern in context to one or more services. The one or more services can be in the condition set of events, the action set of events, or both. A schema is a vocabulary along with a set of constraints on the contained data items. A vocabulary is a collection of names of data items.

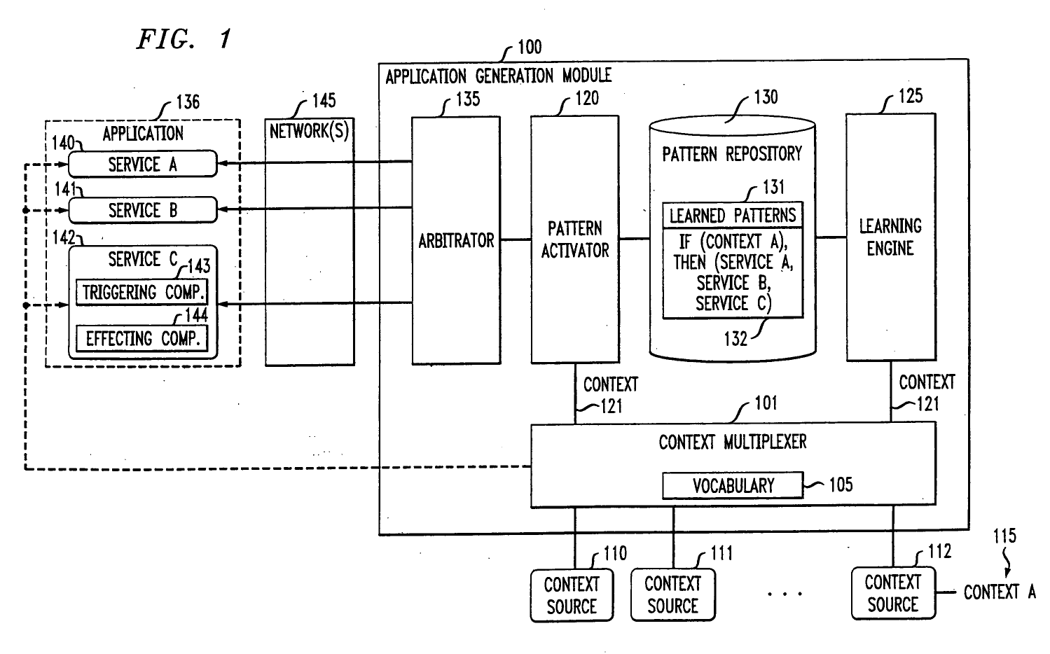

Referring now to FIG. 1, a block diagram of an exemplary application generation module 100 is shown interacting with a number of services 140, 141, 142 through one or more networks 145 and a number of context sources 110, 111, 112. It should be noted that the context sources 110, 111, and 112 may also be connected to the application generation module 100 through one or more networks (not shown), which could be the same networks as networks 145 or different networks. The application generation module 100 comprises a context multiplexer 101, a pattern activator 120, a learning engine 125, a pattern repository 130, and an arbitrator 135. Context multiplexer 101 comprises a vocabulary 105. Pattern repository 130 comprises a number of learned patterns 131, of which one illustrative learned pattern 132 is shown. Application 136 comprises services 140, 141, and 142. As described above, a service generally comprises a triggering component and an effecting component. Service 142 is shown with triggering component 143 and effecting component 144. Services 140 and 141 will also generally comprise triggering and effecting components (not shown).

Context sources 110 are any sources of context, such as an executable entity that records which programs are running on a computer, an executable entity that records which program has the focus on a computer, and an executable entity that records Internet access logs. Context sources 110 include service monitors, which monitor services and provide data about the service.

The context multiplexer 101 serves as an interface to context from context sources 110, 111, 112 that provide context with types that are found in the context vocabulary 105. The context multiplexer 101 logs context 121 and provides the context 121 to the pattern activator 120 and the learning engine 125. The pattern activator 120 listens for context 121 provided through the context multiplexer 101. The context 121 is also delivered to the learning engine 125 so that learned patterns 131 in context 121 can be derived and stored in the pattern repository 130. As described above, a learned pattern 131 is a condition-action pair. The condition and action are both sets of events. The events in the condition trigger the events in the action. In the example of FIG. 1, the learned pattern 132 contains an event “Context A” that is a condition. There is only one event in this condition set of events. The events in a condition set of events are referred to herein as “condition events.” The “Service A, Service B, Service C” is a set of actions. There are three events in the action set of events. The events in an action set of events are referred to as “action events” herein. Learned pattern 132 indicates that in the event of (Context A), then the events of (Service A, Service B, Service C) should be performed.

The arbitrator 135 provides context-triggering scheduling decisions based on communication with the pattern activator 120 so that the services 140, 141, 142 can be properly triggered. In the example of FIG. 1, the application 136 comprises the set of services 140, 141, 142 in this example. The arbitrator 135 need not create an application 136, but can instead independently invoke the services 140, 141, and 142. The application 136 can be any item suitable for comprising a set of services, such as a Java application with N methods, each method corresponding to one of the services either through a remote procedure call or as calls that occur within the same process.

As an example of the operation of the application generation module 100, assume that context source 110 sends context to the context multiplexer 101. The context multiplexer 101 sends the context 121 to the learning engine 125, which determines that learned pattern 132 exists because each time Context A 115 is determined via the context source 112, services 140, 141, and 142 also are used. For example, each time a user enters a particular room, the user might lower an electronically controlled screen (e.g., Service 140), turn on a projector (e.g., Service 141), and load a presentation application on a laptop (e.g., Service 142). To determine that a user has entered a room, a service monitor such as an access point on a wireless network can determine that the user enters the room through communications with the PDA for the user. As another example, the user might log into the laptop, such that a server on the network could determine where the user is. The learning engine 125 determines that learned pattern 132 exists and stores learned pattern 132 in pattern repository 130.

In the present example, Context A 115 is determined to exist by context source 112 and passed through context multiplexer 101 to pattern activator 120. The pattern activator 120 listens for context 121 and determines when Context A 115 (e.g., the person entering the particular room) occurs. As explained above, a service monitor, such as an access point on a wireless network, can determine that the user enters the room through communications with the PDA for the user. The pattern activator 120 then compares the received context 121 with the learned patterns 131 in pattern repository 130. In an embodiment of the present invention, the condition set of events is compared to the context 121. In the present example, the condition set of events for learned pattern 132 is a single event of (Context A). As is known in the art, a condition set of events could be more complex, such as “((Context A OR Context B) OR (Context C AND Context D)).”

The pattern activator 120 compares Context A 115 with the condition event of “Context A” and determines that a match has occurred. The pattern activator 120 then can pass the entire learned pattern 132 to the arbitrator 135 or pass only the action set of events to the arbitrator 135. The action events comprise Service A, Service B, and Service C for learned pattern 132. The arbitrator 135 invokes Service A 140, Service B 141, and Service C 142 based on the learned pattern 132.

Thus, the application generation module 100 is able to execute an application 145, comprising services 140, 141, and 142, based on learned patterns 131 determined from context 121.

It should be noted that there may be patterns in context 121 that do not correlate to services. Illustratively, in the above example, when the user enters the room, the user performs three actions that can be correlated with services. The user may also perform another action, such as turning off his or her cellular phone. There may not be a service available to the application generation module 100 that can turn off the cellular phone. Therefore, this pattern in context is not correlated to a service and usually no learned pattern 131 is stored in pattern repository 130.

It should also be noted that services may be registered with the learning engine 125. This registration is then used to determine what services are available to the application generation module 100. Service registration may be performed through known techniques.

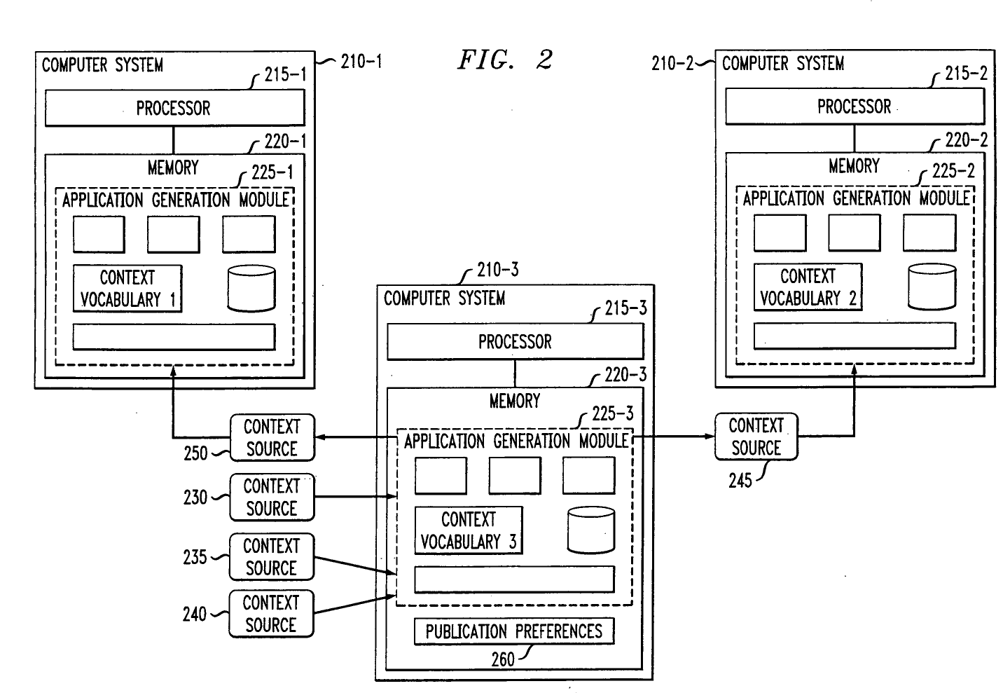

Turning now to FIG. 2, multiple application generation modules in a distributed embodiment are shown. Three application generation modules 225-1, 225-2 and 225-3 are shown. Each of the application generation modules 225 is implemented by a computer system 210. Each computer system 210 comprises a processor 215 and a memory 220. Each memory 220 comprises an application generation module 225, which is formed generally through a number of instructions (not shown) that are loaded into a corresponding processor 215 for execution. Each computer system 210 is connected to each other through context sources, which are generally accessed through networks (not shown).

The application generation modules 225 consume context from context sources. As shown, the application generation module 220-1 consumes context from context source 250, application generation module 220-2 consumes context from context source 245 and application generation module 220-3 consumes context from context sources 230, 235 and 240. Application generation modules 225 can produce context by delivering the output of their corresponding services and defining said output as a context source. As shown, application generation module 220-3 produces context sources 250 and 245.

One benefit to the distributed embodiment shown in FIG. 2 is that public and private access can more easily be controlled. For instance, computer system 210-3 could be a computer system at an enterprise. The enterprise may choose to publish only some of the context determined by context sources 230, 235, and 240. For example, the computer system 210-1 could be a home computer system connected to the Internet (not shown). The computer system 210-1 would like to determine when a user working at the enterprise leaves the enterprise. Such a determination could be used, for instance, to set a thermostat controlled by computer system 210-1 to an appropriate temperature for the user. The context sources 230, 235, 240, may determine many different types of context about the user, but the computer system 210 can determine which context should be published (via context source 250) to the computer system 210-1. This determination may be made through, for instance, publication preferences 260. The publication preferences 260 could be determined by a user, the enterprise, a network administrator, or some combination of these.

As another example, another user in the enterprise accesses computer system 210-2 and attempts to determine where the first user is. The computer system 210-3 accesses the publication preferences 260 and determines that the other user is not allowed access to the location context for the first user. The context source 245 that is then published by the computer system 210-3 may then be empty or could report an “unknown” location.

The present invention described herein may be implemented as an article of manufacture comprising a machine-readable medium, as part of memory 220 for example, containing one or more programs that when executed implement embodiments of the present invention. For instance, the machine-readable medium may contain a program configured to perform steps taken by application generation module 220. The machine-readable medium may be, for instance, a recordable medium such as a hard drive, an optical or magnetic disk, an electronic memory, or other storage device.

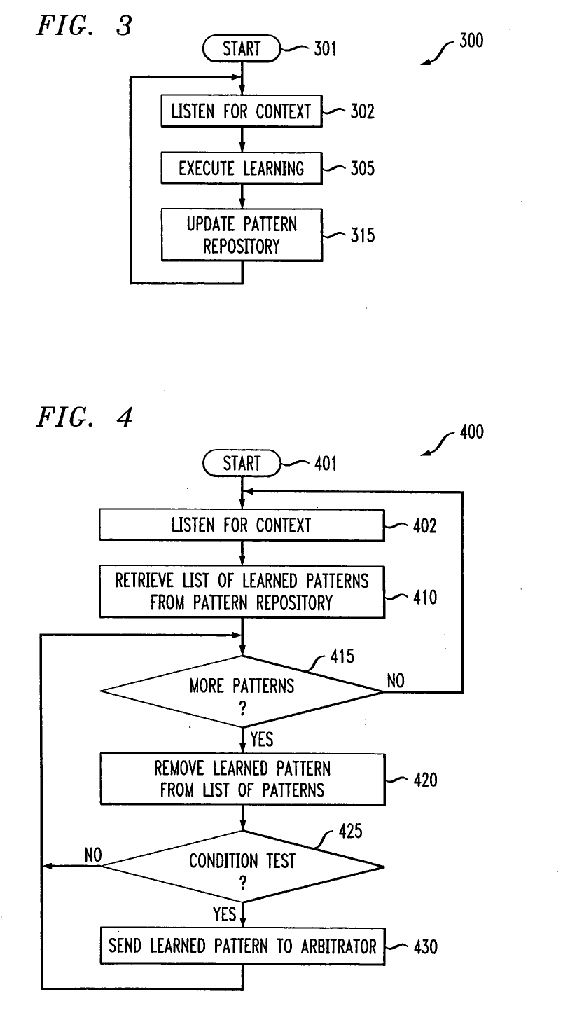

Referring now to FIG. 3, an exemplary method 300 for correlating patterns in context with services is shown. Exemplary method 300 is usually performed by a learning engine 125 of an application generation module 100 or application generation module 225. The method 300 starts in step 301, where initialization steps may be performed. Such steps could include initializing variables and the like. Context is received in step 302. The context is generally received from the context multiplexer 101, but could be received directly through a context source or through any other mechanism. For instance, context may be received manually, such as having a user log into a server and report that the user is in a particular office. In step 305, learning is performed to determine patterns in received context. Step 305 can use any technique for learning patterns, such as a machine learning algorithm like a decision tree algorithm or an association rule. Machine learning algorithms are described in, for instance, Duda, Hart, Stork, Pattern Classification, 2nd Ed., Wiley Interscience (2001), the disclosure of which is hereby incorporated by reference. As described above, a learned pattern comprises a condition-action pair and is determined from context about one or more users. Both the condition and action events may correlate to services. A learned pattern therefore correlates to one or more services or to context.

After step 305, the method 300 then proceeds to step 315, where the pattern repository is updated with learned patterns, if any new learned patterns are found. The method 300 then returns to step 302.

FIG. 4 shows an exemplary method 400 for determining when patterns exist in current context. Method 400 is generally performed by a pattern activator 120 of an application generation module 100 or application generation module 225. The method 400 starts in step 401, which is an initialization step. Context is received in step 402, and the context is generally received from a context multiplexer 101 but could be received directly from a context source or through any other mechanism. Method 400 retrieves a list of learned patterns that are stored in the pattern repository 130 in step 410.

Method 400 decides in step 415 if the list of learned patterns from the context repository 130 is empty. If the list of learned patterns is empty (step 415=NO), then the method 400 returns to step 402. If the list of patterns is not empty (step 415=YES), in step 420, one pattern from the list of patterns is removed. In step 425, it is determined if the condition of the removed learned pattern matches the received context. Matching is well known to those skilled in the art. For instance, received context of Context A matches the condition of (Context A OR Context B), the condition of Context A, and the condition of (Context A OR (Context B AND Context C)), but does not match the condition of (Context A and Context B).

It should be noted that the current context can be used to determine whether a pattern in context has occurred, is occurring, or will occur. For example, if it is known through context that a user has entered a room, the entry of the room has occurred and may be considered to be occurring depending on how a pattern in context is determined. As another example, if a user enters a building, it may be assumed that the user will, in the near future, enter a room belonging to the user. Even though the user has not entered the room, it may be determined through the context that the user will likely enter the room in the near future and a pattern in the context can then be determined based on future actions of the user.

If the received context and condition of the removed learned pattern do not match (step 425=NO), the method returns to step 415. If the received context and the condition of the removed learned pattern do match (step 425=YES) then the removed pattern is sent (e.g., by the pattern activator 120) to the arbitrator 135 in step 430 and method 400 returns to step 415.

It should be noted that step 430 could simply send a set of services to the arbitrator 135. The set of services may include additional information, such as what the order for execution of services is or whether there are additional conditions for execution of the services. Additionally, step 430 could create a single application that comprises the set of services and the application could be sent to the arbitrator 135.

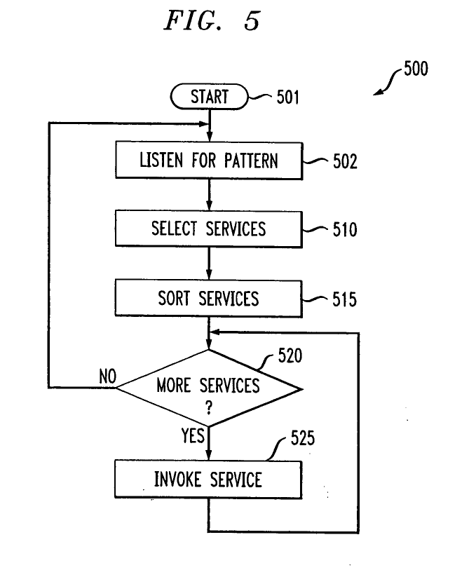

FIG. 5 shows an exemplary method 500 for invoking services. Method 500 is generally implemented by the arbitrator 135. Method 500 starts in step 501, which is an initialization step. In step 502, listening is performed to listen for a learned pattern from the pattern activator 120. When a learned pattern is found, step 510 is performed, which identifies 510 a list of services that correspond to the learned pattern. This list of services is generally contained in the learned pattern. In step 515, the selected services are sorted according to a prioritization scheme. An example embodiment of a prioritization scheme is sorting according to date of service creation. Another example is sorting the services based on level of importance. Step 515 is optional. In step 520, it is determined if the list of services contains any services that have not been invoked. If all services in the list of services have been invoked (step 520=NO), then the algorithm returns to 502. If any service in the list of services has not been activated (step 520=YES), then the service is invoked 525 and the method 500 returns to step 520.

Invocation of a service can be performed through a message to the service to begin execution, execution of the service, remote service invocation (such as a remote procedure call in JAVA) or any other technique that causes or can cause a service to execute. The method 500 may comprise additional steps to deal with additional criteria. For instance, a first service might have a criterion that it is to execute only after a second service has been executed. Step 515 can determine that the second service has executed before the first service has executed.

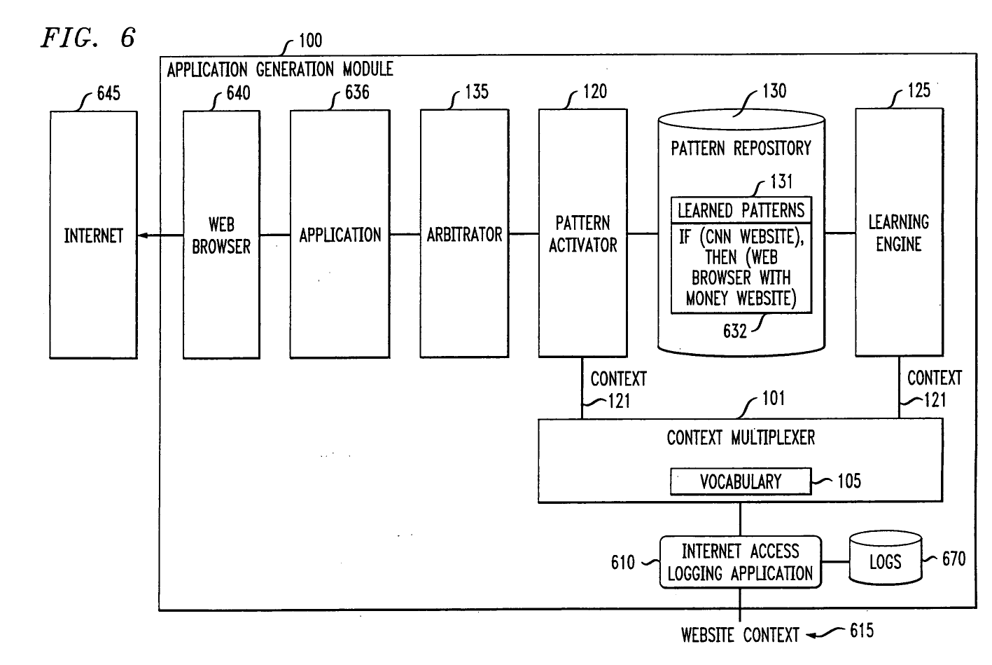

For example, one implementation of an application generation module 100 could use Internet access log data, such as webpages visited, as context. This implementation is shown in FIG. 6. The webpage context 615 may be taken from an Internet access logging application 610. If any patterns are determined in the Internet access logs 670, the webpages in the patterns 131 may be downloaded beforehand. As an example, if a user goes to the CNN webpage then to the Money webpage some predetermined percentage of the time, this is a pattern 632. When the pattern activator 120 determines that the CNN webpage has been visited, the arbitrator 135 can preload the Money webpage by invoking a service that preloads the page. In this example, the service could be a web browser 640 that is given a hypertext transfer protocol (HTTP) address corresponding to the Money webpage. The application 636 could be a Java applet written to provide web browser 640 with an HTTP address or a script to provide the HTTP address.

It is to be understood that the embodiments and variations shown and described herein are merely illustrative of the principles of this invention and that various modifications may be implemented by those skilled in the art without departing from the scope and spirit of the invention.

What is claimed is:

1. A method of invoking at least one service associated with one or more patterns in context of one or more users, the method comprising the steps of:
determining one or more patterns in context corresponding to the one or more users;
correlating the one or more patterns in the context with one or more of a plurality of services; and
invoking the one or more services correlated to the one or more patterns in the context based on current context of the one or more users.

2. The method of claim 1, further comprising the step of determining when the current context indicates that the one or more patterns have occurred, are occurring or will occur, and wherein the step of invoking further comprises the step of invoking the one or more services correlated to the one or more patterns when the current context indicates that the one or more patterns have occurred, are occurring or will occur.

3. The method of claim 1, further comprising the step of generating an application comprising the one or more services.

4. The method of claim 3, wherein the step of invoking the one or more services further comprises the step of executing the application based on current context of the one or more users.

5. The method of claim 1, wherein the context comprises one or more of the following: data about an environment in which a given one of the one or more users is located, characteristics of a given one of the one or more users, and qualities of a given one of the one or more users.

6. The method of claim 1, wherein the step of correlating creates one or more learned patterns, each learned pattern correlating the one or more services to the one or more patterns in the context and wherein the step of invoking further comprises the step of invoking the one or more services in a given one of the learned patterns based on current context of the one or more users.

7. The method of claim 6, further comprising the step of identifying the one or more services based on the learned pattern.

8. The method of claim 6, wherein a given one of the one or more learned patterns comprises a condition-action pair.

9. The method of claim 6, wherein the condition-action pair comprises a set of condition events and a set of action events.

10. The method of claim 9, wherein a service correlates to one or more of a condition event in the set of condition events and an action event in the set of action events.

11. The method of claim 9, wherein the set of action events are to be executed based on whether the set of condition events occur.

12. The method of claim 1, wherein a given one of the one or more services comprises a triggering component and an effecting component.

13. The method of claim 1, wherein the step of correlating further comprises the step of correlating, by using one or more machine-learning algorithms, the one or more patterns in the context with one or more of a plurality of services.

14. The method of claim 13, wherein the one or more machine learning algorithms are part of a set of algorithms, the set including one or more of a decision tree algorithm or an association rule algorithm.

15. The method of claim 1, wherein:
the context comprises Internet access log data;
the step of determining one or more patterns further comprises the step of determining one or more patterns in the Internet access log data with one or more of the plurality of services;
the step of correlating further comprises the step of correlating the one or more patterns in the Internet access log data with one or more of a plurality of services; and
the step of invoking further comprises the step of invoking the one or more services correlated to the one or more patterns in the Internet access log data based on current context of the one or more users, the current context comprising a current webpage, and the one or more services comprising a service to preload another webpage.

16. The method of claim 1, wherein the step of invoking further comprises the step of executing the one or more services correlated to the one or more patterns in the context based on current context of the one or more users.

17. The method of claim 1, wherein the step of invoking further comprises the step of sending one or more messages to the one or more services correlated to the one or more patterns in the context based on current context of the one or more users, the one or more messages requesting that the one or more services execute.

18. The method of claim 1, further comprising the step of publishing the context based on publication preferences.

19. An article of manufacture for invoking at least one service associated with one or more patterns in context of one or more users, comprising:
a computer readable medium containing one or more programs which when executed implement the steps of:
determining one or more patterns in context corresponding to the one or more users;
correlating the one or more patterns in the context with one or more of a plurality of services; and
invoking the one or more services correlated to the one or more patterns in the context based on current context of the one or more users.

20. An apparatus for invoking at least one service associated with one or more patterns in context of one or more users, comprising:
a memory; and
at least one processor, coupled to the memory, operative to:
determine one or more patterns in context corresponding to the one or more users;
correlate the one or more patterns in the context with one or more of a plurality of services; and
invoke the one or more services correlated to the one or more patterns in the context based on current context of the one or more users.
